(19) United States
(12) Patent Application Publication
(10) Pub. No.: US 2023/0367117 A1
(43) Pub. Date: Nov. 16, 2023

(54) EYE TRACKING USING CAMERA LENS-ALIGNED RETINAL ILLUMINATION

(71) Applicant: Apple Inc., Cupertino, CA (US)

(72) Inventors: Itai Afek, Ramat Gan (IL); Roei Remez, Tel Aviv (IL); Ariel Lipson, Tel Aviv (IL)

(21) Appl. No.: 18/143,213

(22) Filed: May 4, 2023

Related U.S. Application Data
(60) Provisional application No. 63/342,322, filed on May 16, 2022.

(51) Int. Cl. G02B 27/00; G02B 27/01

(52) U.S. Cl. CPC G02B 27/0093; G02B 27/0172; G02B 2027/0138

(57) ABSTRACT

Various implementations disclosed herein include devices, systems, and methods that capture images of an illuminated retina and perform eye tracking using the images. For example, a newly capture image may be compared with a previously-captured image or model of the retina to determine a three dimensional (3D) position or orientation of the eye, relative to the camera/tracking system. Diffuse light is directed towards the retina to produce reflections that are captured by the camera. The diffuse light is directed from positions that better aligned with the camera than prior retinal-imaging techniques. For example, at least some of the diffuse light may be directed towards the retina from one or more positions that are less than the camera lens' aperture radius distance from the camera lens' optical axis.

### CROSS-REFERENCE TO RELATED APPLICATIONS

This Application claims the benefit of U.S. Provisional Application Ser. No. 63/342,322 filed May 16, 2022, which is incorporated herein in its entirety.

### TECHNICAL FIELD

The present disclosure generally relates to electronic devices, and in particular, to systems, methods, and devices for tracking eye characteristics of users of electronic devices.

### BACKGROUND

Some existing eye-tracking techniques produce light that is reflected off of a user's eye (e.g., typically the user cornea) as one or more glints that are captured in images via an image sensor. The patterns of the glints in the images may be analyzed to determine positions or orientations of user eyes. Existing tracking systems may lack efficiency, accuracy, or other characteristics that are desirable for various eye tracking applications.

### SUMMARY

Various implementations disclosed herein include devices, systems, and methods that capture images of an illuminated retina and perform eye tracking using the images. For example, a newly capture image may be compared with a previously-captured image or model of the retina to determine a three dimensional (3D) position or orientation of the eye, relative to the camera/tracking system or surrounding environment. The light is intended to illuminate the retina, that is then imaged by the camera. Diffuse light may be directed from positions that better aligned with the camera than prior eye-tracking techniques. For example, at least some of the diffuse light may be directed towards the retina from inside the working-Numerical-Aperture of the lens, meaning that the illumination is positioned close to the optical axis, inside the clear aperture of the lens or directly in front of it. Some implementations provide eye tracking capabilities using one or more modular camera attachment-enabled optical (MCO) devices that are sufficiently small for use on head-mounted devices and other devices that are sensitive to size constraints.

Some implementations involve a retinal imaging device that has a camera, a light source, and a scattering optic that is used to produce diffuse light towards a retina of an eye. The camera has a lens having an optical axis and a clear aperture radius (the radius of the entrance pupil of the lens). At least some of the diffuse light is directed towards the retina from positions less than the lens' aperture radius distance from the lens optical axis, and thus the diffuse light is better aligned with the camera's optical axis. The scattering optic may be small to avoid/limit interference with light captured by the camera and to avoid a requirement to significantly increase device size to accommodate production of the diffuse light. Diffuse light may be produced from positions that are closer to the optical axis of the lens, providing better retinal imaging, especially when the pupil is contracted, without requiring a significant increase in device size. The light may also be polarized to reduce/avoid glint/ghost corneal reflections.

Some implementations provide devices that include a camera having a chamber with an aperture fitted with a lens through which captured light is received to form images that are projected onto a surface for recording or translation into electrical impulses. The camera lens has a lens optical axis and a lens aperture radius. These exemplary devices may include a light source and a scattering optic. The light source may be configured to produce light that is directed towards the scattering optic. The scattering optic may be positioned and configured to produce diffuse light by scattering the light produced by the light source, where at least some of the diffuse light is directed from a position around the optical axis and closer to it than the aperture radius (e.g., within the lens' aperture radius distance from the optical axis), and directed towards a retina of an eye. The captured light includes reflections of the diffuse light off of the retina. The device may also include one or processors configured to track the eye based on the images.

Some implementations provide devices that include a camera and an outward light source configured and positioned to produce light such that the at least some of the produced light is directed towards the retina. The light source may be configured to avoid/limit interference with light captured by the camera. For example, a device may include a camera having a chamber with an aperture fitted with a lens through which captured light is received to form images that are projected onto a surface for recording or translation into electrical impulses, the camera lens having a lens optical axis and a lens aperture radius. The device may include a light source configured to produce diffuse light, where at least some of the diffuse light is produced from the light source at a position that is less than the lens aperture radius distance from the lens optical axis and directed towards a retina of an eye. The captured light includes reflections of the diffuse light off of the retina. The device may include one or more processors configured to track the eye based on the images.

Some implementations provide an eye tracking method. The method may involve generating diffuse light directed towards a retina of an eye. The method may further involve generating an image of the retina using a camera comprising a lens having a lens optical axis and a lens aperture radius distance, where the image is generated by capturing reflections of the diffuse light off of a retina of an eye. At least some of the diffuse light may be directed from a position that is less than the lens aperture radius distance from the lens optical axis. The method may track the eye (e.g., the eye's 3D position, orientation, retinal characteristics, etc.) based on the image.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary device according to some implementations.

FIGS. 2A-2B illustrate the exemplary device of FIG. 1 performing eye tracking in accordance with some implementations.

FIGS. 3A-3B illustrates portions of an eye captured using off axis illumination given different pupil sizes.

FIGS. 4A-4B illustrate an exemplary eye tracking device in accordance with some implementations.

FIGS. 5A, 5B, 5C illustrate additional exemplary eye tracking devices in accordance with some implementations.

FIG. 6 illustrates an exemplary eye tracking device in accordance with some implementations.

FIG. 7 illustrates light diffusion by the eye tracking device of FIG. 6, in accordance with some implementations.

FIG. 8 illustrates an exemplary eye tracking device in accordance with some implementations.

FIG. 9 illustrates an exemplary eye tracking device in accordance with some implementations.

FIG. 10 illustrates an exemplary eye tracking device in accordance with some implementations.

FIG. 11 illustrates an exemplary eye tracking device in accordance with some implementations.

FIGS. 12A-12B illustrate exemplary lens configurations in accordance with some implementations.

FIG. 13 illustrates an exemplary eye tracking device in accordance with some implementations.

FIG. 14 illustrates an attachment of a light source in the exemplary eye tracking device of FIG. 13, in accordance with some implementations.

FIG. 15 illustrates an exemplary eye tracking device in accordance with some implementations.

FIG. 16 is a flowchart representation of a method for tracking an eye characteristic in accordance with some implementations.

FIG. 17 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

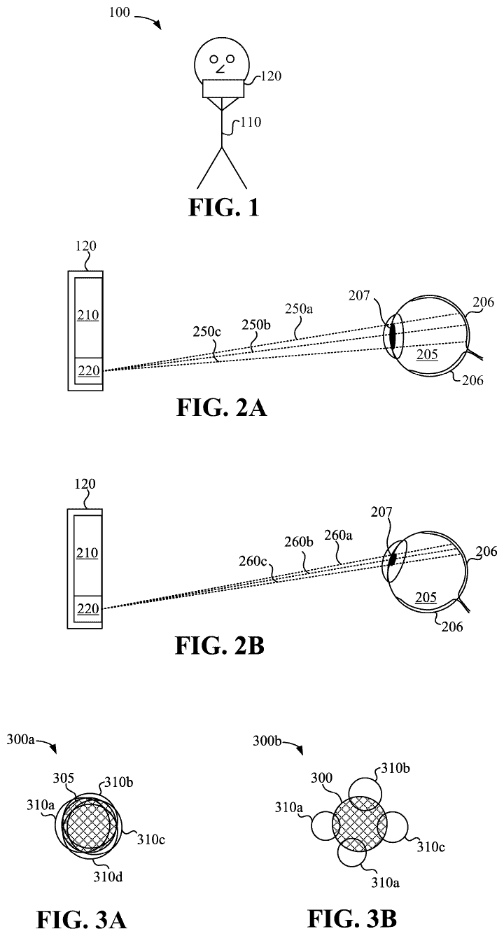

FIG. 1 illustrates an example environment 100 including a device 120. In some implementations, the device 120 displays content to a user 110. For example, content may include a user interface or portions thereof, e.g., a button, a user interface icon, a text box, a graphic, etc. In some implementations, the content can occupy the entire display area of a display of the device 120. The device 120 may obtain image data, motion data, and/or physiological data from the user 110 via one or more sensors. For example, the device 120 may obtain eye characteristic data via an eye tracking module. Such an eye tracking module may include one or more illumination components (e.g., light sources, scattering optics, etc.) and camera components (e.g., light sensors, lenses, polarizers, etc.).

While this example and other examples discussed herein illustrate a single device 120, the techniques disclosed herein may utilize multiple devices. For example, eye tracking functions of device 120 may be performed by multiple devices, e.g., with a camera, light source, and/or scattering optics, on each respective device, or divided among them in any combination.

In some implementations, as illustrated in FIG. 1, the device 120 is a handheld electronic device (e.g., a smartphone or a tablet). In some implementations the device 120 is a laptop computer or a desktop computer. In some implementations, the device 120 has a touchpad and, in some implementations, the device 120 has a touch-sensitive display (also known as a “touch screen” or “touch screen display”). In some implementations, the device 10 is a wearable device such as a head-mounted device (HMD).

In some implementations, the device 120 includes an eye-tracking system for detecting eye characteristics such as eye position and eye movements. For example, an eye-tracking system may include an eye tracking camera (e.g., IR or near-IR (NIR) camera), and an illumination source (e.g., an IR or NIR light source) that emits light towards the eyes of the user 110. The illumination source of the device 120 may emit light that is directed (e.g., via scattering optics) to illuminate the retina of an eye of the user 110 and the camera may capture images of the retina by capturing reflections of that light off of the retina. In some implementations, images captured by the eye-tracking system may be analyzed to detect position and movements of the eyes of the user 110, or to detect other information about the eyes such as medical information such as retinal health, retinal changes, cholesterol conditions, etc. Moreover, in some implementations, retinal imaging is used to determine a 3D orientation of one or both eyes, which may be used to determine gaze direction, identify objects that the user 110 is looking at, identify changes in gaze, determine gaze velocities, etc.

In some implementations, the device 120 has a graphical user interface (GUI), one or more processors, memory and one or more modules, programs or sets of instructions stored in the memory for performing multiple functions. In some implementations, the user 110 interacts with the GUI by providing input, e.g., via gestures and/or gaze-based input. In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

FIGS. 2A-2B illustrates the device 120 of FIG. 1 capturing images of a retina 206 of the eye 205 when the eye 205 is in different orientations. The device 120 includes a display 210 and eye tracking system 220. The eye-tracking system 220 uses a light source and/or scattering optics to direct diffuse light 250a-c through the pupil 207 and onto the retina 206. Additionally, the eye-tracking system 220 includes a camera (e.g., image sensor) to observe the light 250a-c after it is reflected off of the retina 206 of the eye 205 in order to acquire one or more images of the retina 206. The images may depict blood vessels and other structures and characteristics of the retina 206. A comparison of FIGS. 2A and 2B illustrates how the portion of the retina that is illuminated and captured in the images will depend upon the orientation of the eye 205 and the size of the pupil 207 opening.

Ideally, relatively large portions of the central portion of the retina 206 are captured in the images. Capturing relatively large portions of the central portion of the retina 206 may improve the efficiency, accuracy, or other attributes of the functions to which the retinal images are used. For example, tracking the position/orientation of the eye 205 based on the retinal images may be more efficient, accurate, and available to track a greater range of eye orientations and/or pupil opening sizes given images of relatively large portions of the central portion of the retina 206. Obtaining images of relatively large portions of the central portion of the retina 206 may require aligning the positions from which the diffuse light is directed towards the eye 205 with the camera.

Images obtained based on diffuse light that is not so aligned with the optical axis of the camera may not produce adequate retina images. For example, FIGS. 3A-3B illustrate illuminated eye/retina portions relative to camera captured eye/retina portions given four light sources that are not sufficiently aligned with the optical axis of the camera. In FIG. 3A, the pupil opening was relatively large and the eye was aligned towards the image tracking system (e.g., as illustrated in FIG. 2A). In this case, the illuminated eye/retina portions 310a-d substantially overlap with the captured eye/retina portion 305. In contrast, in FIG. 3B, the pupil opening was relatively small and the eye was not aligned towards the image tracking system (e.g., as illustrated in FIG. 2B). In this case, the illuminated eye/retina portions 310a-d do not substantially overlap with the captured eye/retina portion 305. This illustrates a significant disadvantage of using a retinal imaging system in which the illumination is not aligned both spatially and angularly with the optical axis of the camera.

In some direct retinal imaging applications, it is desirable or necessary to employ a camera-aligned (e.g., coaxially aligned) illumination system to ensure greater overlap of the illuminated area of the retina and the captured field of view. This may be particularly true for applications in which small eye-pupil openings are expected to occur and in which non-aligned illumination will provide little or no overlap with the camera field of view.

Implementations disclosed herein provide devices and techniques that enable retinal imaging in which the illumination and camera capture are better aligned than prior systems and thus are better suited to capture retinal images of illuminated retina portions. The devices and techniques disclosed herein may enable more efficient and accurate retinal imaging in a broader range of circumstances, e.g., for a broader range of pupil opening sizes and/or eye orientations. According to some aspects, the improved alignment may improve accuracy with respect to determining an eye position/orientation and/or an accommodation depth/distance of the eye. The devices and techniques disclosed herein may provide retinal imaging on devices that are subject to size, power, and/or processing constraints. Implementations disclosed herein may be well-suited for eye tracking applications on mobile and/or head-mounted devices (HMDs).

Implementations that provide eye tracking may do so based on previously obtained information about the eye, e.g., such as a prior retinal image or retinal representation generated based on prior retinal images from an enrollment process. In some implementations, a representation of the retina provides a mapping of distinguishing retinal features such that a later-obtained image can be matched with the mapping. Based on such matching, the position/orientation of the retina and thus the eye as a whole may be determined. Similarly, since the eye lens may be focused at different depths, which will result in changes (e.g., reducing or enlarging) the captured retinal image content, comparing a retinal image with a previously-obtained retinal mapping (associated with a given accommodation level) may provide information about retina's current accommodation (i.e., at the time of the captured retinal image content).

Some implementations are additionally configured to reduce or illuminate the appearance in retinal images of specular reflections/glints off of the cornea of the eye. For example, the illumination emitted towards the eye may have a certain polarization and the camera may utilize a perpendicular polarization. Such cross polarization may reduce or eliminate the appearance of corneal reflections/glints in the captured images.

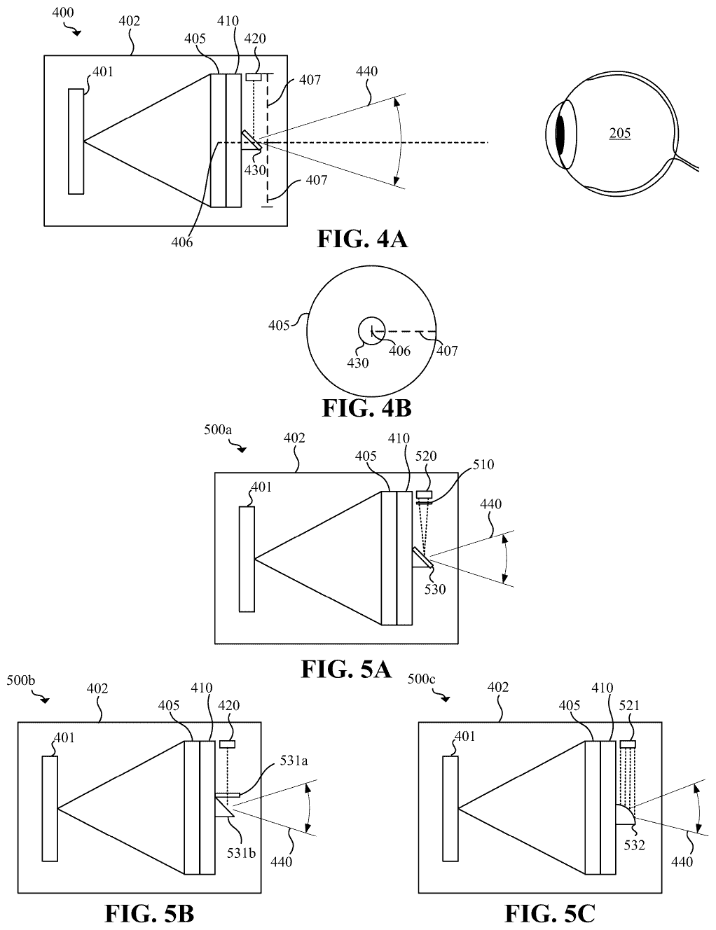

FIGS. 4A-4B illustrate an exemplary eye tracking device 400. The eye tracking device 400 includes a housing 402 that at least partially encloses an image sensor 401, a camera lens 405 within an aperture, a polarizer 410, a light source 420, and a scattering optic 430. The image sensor 401 may include any type of sensor capable of capturing images based on receiving light, e.g., a CMOS sensor configured to convert the charge from photosensitive pixels to voltages at individual pixel sites that are recorded as images of pixel values in rows and columns. The image sensor 401 may be configured to capture the same type of light (e.g., IR light, light within a particular wavelength range, etc.) as is the light that is emitted by the light source 420. The polarizer 410 may be configured perpendicular to the illumination polarization.

The lens 405 may be configured to focus light on the image sensor 401. The lens 405 has an optical axis and an aperture diameter 407 (twice the lens aperture radius distance).

The light source 420 emits directed and/or polarized light towards the scattering optics 430. For example, the light source may be a collimated polarized light emitting diode (LED). The scattering optics may be positioned to direct received light towards the eye 205. In this example, the scattering optic 430 is a reflective diffuser at a 45 degree angle relative to the light source and a 45 degree angle relative to the lens optical axis 406. As illustrated in FIGS. 4A and 4B, some implementations provide a device in which a light source 420 provides collimated light from a side of an eye tracking device 400 towards a scattering optic 430 that redirects and diffuses the light towards a retina of an eye 205 from positions aligned with the image sensor 401 and/or lens 405. Such a scattering optic 430 may have attributes that make it both at least partially reflective and configured to produce diffuse light 440. In alternative configurations, the scattering optic is an optical element that has diverging optical power, e.g., without necessarily having every point spreading light differently. Any type of light diffusing or spreading component may be used.

As illustrated in FIGS. 4A and 4B, the scattering optic 430 is aligned with the lens 405. In this example, the scattering optic 430 is co-axially aligned with the lens 405, i.e., the center of the scattering optic is positioned along the optical axis 406 of the lens 405. The positioning allows the scattering optic 430 to redirect light from the light source 420 as diffuse light 440 directed towards the eye 205. At least some of the diffuse light 440 is directed from a position that is less than the lens aperture radius (half of diameter 407) from the lens optical axis 406 and directed towards a retina of the eye 205.

The image sensor 401 captures captured light that includes reflections of the diffuse light 440 from the retina of the eye 205. Such images of the retina and/or other eye portions may be used to determine and/or track the position, orientation, accommodation, retinal characteristics, and/or other eye characteristics.

FIGS. 5A, 5B, 5C illustrate additional exemplary eye tracking devices 500a-c. In FIG. 5A, the eye tracking device 500a includes a housing 402 that at least partially encloses an image sensor 401, a camera lens 405 within an aperture, a polarizer 410, a light source 520, and a scattering optic 530. In this example, the light source 420 is a diverging light source that is focused by focusing element 510 on the scattering optic 530, which may enable the use of a relatively smaller scattering optic 530 (e.g., relative to the scattering optic 430 of FIGS. 4A-4B). The scattering optic 530 directs diffuse light 440 towards the eye.

In FIG. 5B, the eye tracking device 500b includes a housing 402 that at least partially encloses an image sensor 401, a camera lens 405 within an aperture, a polarizer 410, a light source 420, and scattering optic that has components 531a-b. In this example, a diffuser component 531a of the scattering optic produces diffuse light that is redirected by reflection component 531b as diffuse light 440 directed towards the eye.

In FIG. 5C, the eye tracking device 500c includes a housing 402 that at least partially encloses an image sensor 401, a camera lens 405 within an aperture, a polarizer 410, a light source 521, and scattering optic 532. In this example, the scattering optic 532 is a curved reflector having a shape/curvature that dictates the spreading of the diffuse light, e.g., within the camera field of view.

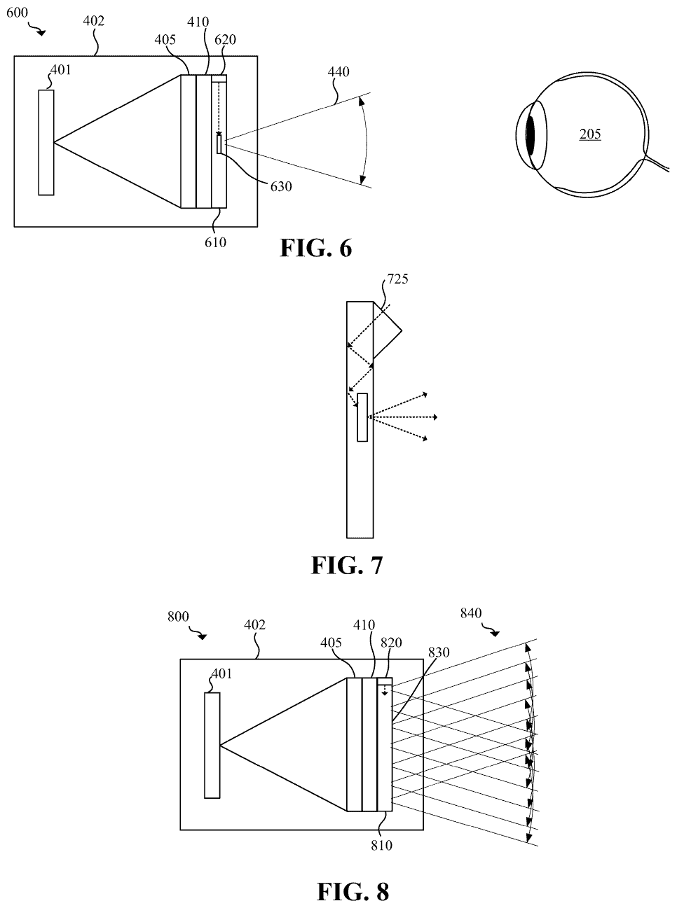

FIG. 6 illustrates an exemplary eye tracking device 600. The eye tracking device 600 includes a housing 402 that at least partially encloses an image sensor 401, a camera lens 405 within an aperture, a polarizer 410, a waveguide 610, a light source 620, and scattering optic 630. As illustrated in FIG. 7, light produced by light source 620 (e.g., a collimated polarized LED) may be injected into the waveguide 610 via coupling prism 725 or other diffractive optics and travel within waveguide 610, e.g., based on internal reflection, which may be total internal reflection, along at least a portion of the waveguide 610. The scattering optic 630 is one or more multi-directional output couplers partially over the aperture that directs this internally-reflected light out of the waveguide 610 as diffuse light 440 directed towards the eye 205, e.g., via diffractive optical elements. The scattering optic 630 may include several small output couplers with different properties. The scattering optic 630 may include transparent elements that do not block the image sensor 401 from capturing image data. The scattering optic 630 may spread the light out and maintain polarization but also allow light reflections to travel to the image sensor 401.

FIG. 8 illustrates an exemplary eye tracking device 800. The eye tracking device 800 includes a housing 402 that at least partially encloses an image sensor 401, a camera lens 405 within an aperture, a polarizer 410, a waveguide 810, a light source 820, and scattering optic 830 along the front surface of the waveguide 810. Light produced by light source 820 (e.g., a collimated polarized LED) may be injected into the waveguide and travel within waveguide 810, e.g., based on internal reflection. The scattering optic 830 is a multi-directional output coupler over the entire lens aperture that directs this internally-reflected light out of the waveguide 810 as diffuse light 840 directed towards the eye, e.g., via diffractive optical elements. The scattering optic 830 may include transparent elements that do not block the image sensor 401 from capturing image data. The scattering optic 830 may spread the light out and maintain polarization but also allow light reflections to travel to the image sensor 401. The waveguide 810 may be at least partially transparent from the image sensor's 401 point of view.

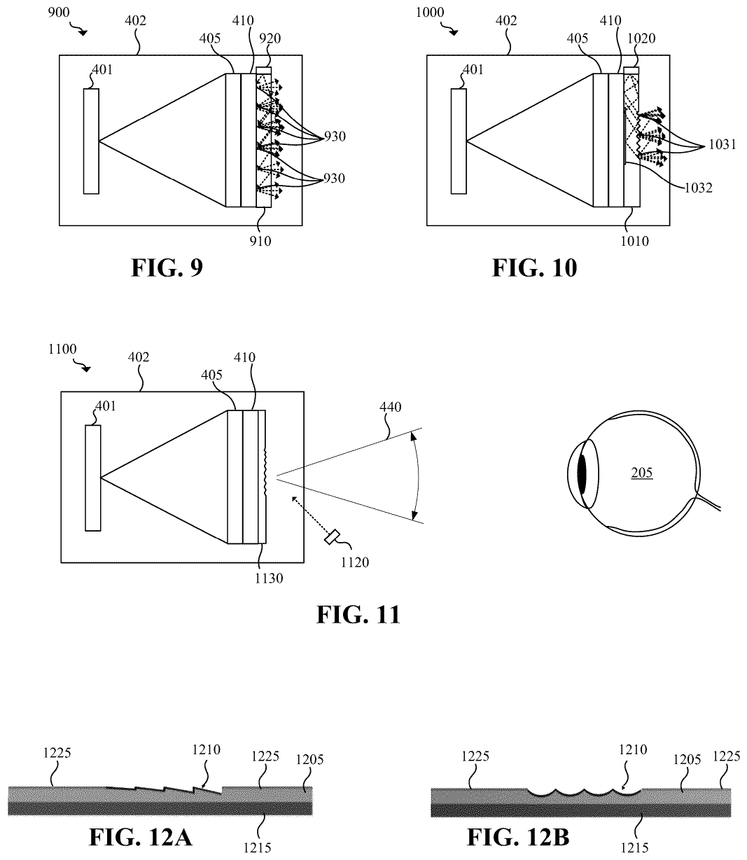

FIG. 9 illustrates an exemplary eye tracking device 900. The eye tracking device 900 includes a housing 402 that at least partially encloses an image sensor 401, a camera lens 405 within an aperture, a polarizer 410, a waveguide 910, a light source 920, and scattering optic 930 along the rear surface of the waveguide 910. Light produced by light source 920 (e.g., a collimated polarized LED) may be injected into the waveguide 910 and travel within waveguide 910, e.g., based on internal reflection. The scattering optic 930 may spread the light out and maintain polarization but also allow light reflections to travel to the image sensor 401. The waveguide 910 may be transparent from the image sensor's 401 point of view.

The scattering optics 930 may include a dense (or sparse) array of very small reflectors on the waveguide 910 that direct light in a wide span of angles towards the eye. The scattering optics 930 may include multiple relatively small but densely positioned scattering elements such that each time light hits one of these scattering elements, it scatters towards the eye. The waveguide 910 may include such scattering elements and thus have less than total internal reflection. The scattering elements may be embedded in a surface of the waveguide, e.g., by etching small defects in the glass or other material forming the waveguide 910. The scattering elements may be embedded in the waveguide 910 by injecting small particular in the waveguide 910, e.g., near a waveguide surface. The amount and/or positioning of such scattering elements may depend upon the retinal imaging application and may be selected to provide a desirable or sufficient amount of illumination for the particular application. A sparse set of scattering elements may produce illumination of a retina that is sufficient for some applications. Similarly, scattering elements need not cover an entire surface of the waveguide 910 for some applications.

FIG. 10 illustrates an exemplary eye tracking device 1000. The eye tracking device 1000 includes a housing 402 that at least partially encloses an image sensor 401, a camera lens 405 within an aperture, a polarizer 410, a waveguide 1010, a light source 1020, and a scattering optic that include scattering elements 1031 along a front surface and a mirrored coating 1032 along the rear surface of the waveguide 1010. Light produced by light source 1020 (e.g., a collimated polarized LED) may be injected into the waveguide 1010 and travel within waveguide 1010, e.g., based on internal reflection. The scattering optic may spread the light out and maintain polarization but also allow light reflections to travel to the image sensor 401. The waveguide 1010 may be transparent from the image sensor's 401 point of view.

The scattering optics may include scattering elements 1031 that are a dense (or sparse) array of very small reflectors on the waveguide 1010 that direct light in a wide span of angles towards the eye or towards a partial back mir. The scattering elements 1031 may include multiple relatively small but densely-positioned scattering elements such that each time light hits one of these scattering elements, it scatters towards the eye. The waveguide 1010 may include such scattering elements and thus have less than total internal reflection. The amount and/or positioning of such scattering elements 1031 may depend upon the retinal imaging application and may be selected to provide a desirable or sufficient amount of illumination for the particular application. A sparse set of scattering elements may produce illumination of a retina that is sufficient for some applications. Similarly, scattering elements need not cover the entire surface of the waveguide 1010 for some applications.

The mirrored coating 1032 on the waveguide 1010 can also direct light out of the waveguide 1010 and towards the eye. In some implementations, the scattering elements 1031 scatter light back towards the mirrored coating 1032, which reflects the scattered light as diffuse light at least some of which is directed towards the eye. The mirrored coating 1032 may be positioned near the optical axis of the lens 405 such that the diffuse light directed towards the eye is closely aligned with the camera elements. The mirror element 1032 may be polarization dependent and may or may not be included.

FIG. 11 illustrates an exemplary eye tracking device 1100. The eye tracking device 1100 includes a housing 402, an image sensor 401, a camera lens 405 within an aperture, a polarizer 410, a scattering optic 1135, and a light source 1120. Light produced by light source 1120 (e.g., a collimated polarized LED) is directed towards the scattering optic 1130, which in one example is a mirror-coated Fresnel lens. The scattering optic 1130 reflect this light as diffuse light 440 and maintains polarization, but also allow light reflections to travel to the image sensor 401. The scattering optic 1130 may be achieved by coating a portion (e.g., a center area) of a lens (e.g., lens 405 or polarizer 410) with a mirror coating and/or etching the surface of such a lens. The light source 1120 may provide light from within the housing 402 or from outside of the housing 402 of the eye tracking device 1100.

FIGS. 12A-12B illustrate exemplary configurations of the scattering optics 1130 of FIG. 11. FIG. 12A illustrates a configuration in which an SiO₂ layer 1205 is adjacent to a polarizer 1215, where the SiO₂ layer 1205 has an anti-reflective coating 1225 for side portions and a mirror coating 1210 for a central portion. Similarly, FIG. 12B illustrates a configuration in which an SiO₂ layer 1205 is adjacent to a polarizer 1215, where the SiO₂ layer 1205 has an anti-reflective coating 1225 for side portions and a mirror coating 1210 for a central portion. The geometric shape of the central portion that has the mirror coating 1210 may have various irregular/non-planar configurations that produce diffuse light reflections of light from the light source 1120 towards the eye 205.

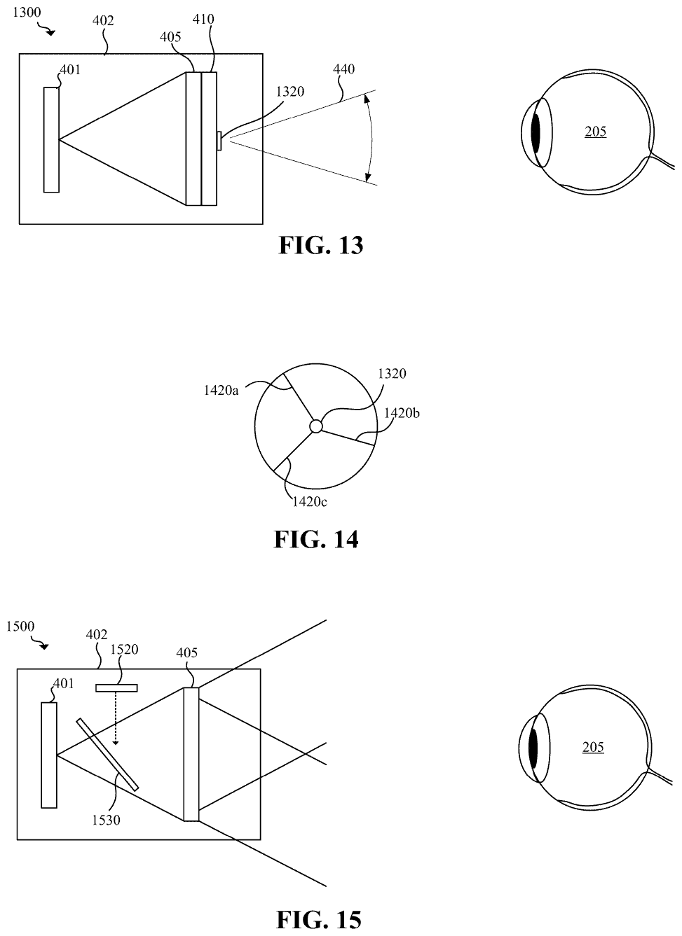

FIG. 13 illustrates an exemplary eye tracking device 1300 that uses outward facing illumination. The eye tracking device 1300 includes a housing 402 that at least partially encloses an image sensor 401, a camera lens 405 within an aperture, a polarizer 410, and a light source 1320. The light source may comprise one or more LEDs, a VCSEL array, etc., may be configured to produce polarized light, and/or may be attached in a way that minimizes blockage of returning light reflections. Light produced by light source 1320 is diffuse light directed towards the eye 205.

In some implementations, the light source 1320 is secured (e.g., on the lens 405 or polarizer 410) using transparent attachment components, e.g., securing wires. FIG. 14 illustrates an attachment of a light source 1320 in the exemplary eye tracking device 1300 of FIG. 13. In this example, the light source 1320 is secured in position using transparent wires 1420a-c. The mechanical holding structure (e.g., transparent wires 1420a-c) may additionally be used to carry control and current supply for the light source 1320. The light source may additionally or alternatively be attached to an optical surface using an adhesive.

The light source 1320 may be sized to minimize the amount of blocking, e.g., blocking less than 40%, 30%, 20%, 10%, 5% of the aperture of the camera lens 405. In some implementations, the light source 1320 has a circular cross section (as illustrated in FIG. 14). In other implementations, the light source 1320 has a linear, rectangular, or other shape, e.g., for example, comprising a strip of multiple LEDs in a linear arrangement.

In some implementations, an illumination source (e.g., a sparse illumination board such as a micro-LED array) is co-aligned and in front of the image sensor, so that the image sensor can sense through the illumination. Both the illumination source and the image sensor may use the same lens.

FIG. 15 illustrates an exemplary eye tracking device 1500. The eye tracking device 1500 includes a housing 402 that at least partially encloses an image sensor 401, a camera lens 405 within an aperture, an optic 1530, and a light source 1520. Light produced by light source 1520 (e.g., a collimated polarized LED) is directed towards the optic 1530, which reflects this light as diffuse light towards the eye 205 and maintains polarization. The optic 1530 may be a miniaturized (e.g., smaller than housing 402, smaller than the lens, etc.) polarized beam splitter (PBS) plate that in front of the image sensor 401 but behind the lens 405, i.e., packaged within the camera module. In alternative implementations, an optic 1530, such as a PBS plate, is positioned in front of lens 405 and/or not packaged within the camera module.

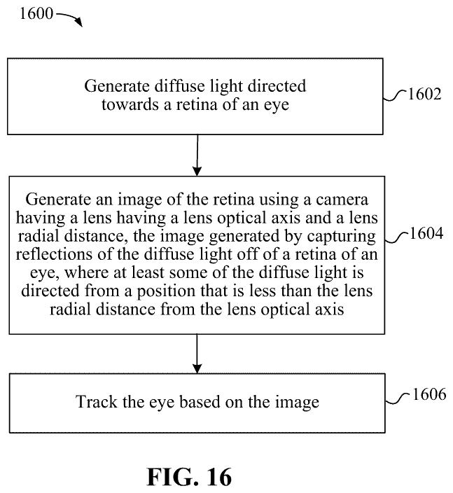

FIG. 16 is a flowchart illustrating an exemplary method 1600 for tracking an eye characteristic. In some implementations, a device (e.g., device 120 of FIG. 1) performs the techniques of method 1600. In some implementations, the techniques of method 1600 are performed on a mobile device, desktop, laptop, HMD, or server device. In some implementations, the method 1600 is performed by processing logic, including hardware, firmware, software, or a combination thereof. In some implementations, the method 1600 is performed on a processor executing code stored in a non-transitory computer-readable medium (e.g., a memory).

At block 1602, the method 1600 generates diffuse light directed towards a retina of an eye and, at block 1604, the method 1600 generates an image of the retina using a camera comprising a lens having a lens optical axis and a lens aperture radius. The image is generated by capturing reflections of the diffuse light off of a retina of an eye, where at least some of the diffuse light is directed from a position that is less than the lens aperture radius distance from the lens optical axis. At block 1606, the method 1600 tracks the eye based on the image.

In some implementations, the diffuse light is directed by a scattering optic or light source, where an entirety of the scattering optic or light source is within the lens aperture radius distance from the lens optical axis. Such optional positioning is illustrated in the exemplary devices of FIGS. 4, 5A-C, 6, 7, 8, 11, 13, 14, and 15.

In some implementations, the method 1600 is performed at a device that has a camera having an angle of view and the diffuse light is scattered across the entire angle of view of the camera. In some implementations, the method 1600 directs diffuse light from a position relative to the eye and camera that is sufficiently diffuse such that at least some of the diffuse light will be directed towards and illuminate the retina regardless of the rotational orientation of the eye, e.g., throughout the full range of potential eye rotational orientation, and reflections of such light will be captured by the camera.

In some implementations, the method 1600 is performed at a device that includes a waveguide that directs the diffuse light, where the light source directs the light source into the waveguide. Examples of such configurations are illustrated in FIGS. 6, 7, 8, 9, and 10. In some implementations, the waveguide comprises a scattering optic and the scattering optic comprises a diffusion plate comprising a plurality of scattering elements, as illustrated in FIG. 9. Such a plurality of scattering elements may be etched into a surface of the waveguide or may be particles injected into the waveguide. In some implementations, the waveguide comprises an embedded diffuser and partial back coating, as illustrated in FIG. 10.

In some implementations, the waveguide comprises a multi-directional output coupler, as illustrated in FIGS. 8-10. The multi-directional output coupler may be positioned over an entirety of an aperture of the lens, as illustrated in FIG. 10, or positioned over less than an entirety of the aperture, as illustrated in FIGS. 8-9.

In some implementations, the light is directed towards a scattering optic by a collimated light emitting diode (LED), as illustrated in FIGS. 4A-B, 5A-C, 11, and 15.

In the method 1600, the scattering optic may be a reflective diffuser, a plurality of scattering elements, or a mirror coating.

In some implementations, the method 1600 uses a relatively small beam splitter within a camera module. For example, the light source and the scattering optic are within a chamber of the camera, where the light source comprises a light emitting diode (LED), the scattering optic comprises a diffuser and a polarized beam splitter, and where the LED directs the directed light through the diffuser, the diffuser scatters the directed light, and the polarized beam splitter reflects the scattered light in diffuse directions. Such a configuration is illustrated in FIG. 15.

In some implementations, the diffuse light directed towards the retina and light captured by the camera have perpendicular polarizations. For example, the diffuse light may have a first polarization that is perpendicular to a second polarization of the captured light.

In some implementations, the method 1600 is performed by a head mounted device (HMD). The camera and illumination components of the eye tracking system on such an HMD may be located at a fixed position on the HMD and thus be used to track the eye's position and/or orientation relative to the HMD over time. A camera, a light source, and a scattering optic of an eye tracking module may be housed within a housing that is affixed to a frame portion of the HMD. In some cases, the eye tracking system provides real-time, live eye tracking as the user uses the HMD to view the surrounding physical environment and/or content displayed on the HMD, e.g., as an extended reality (XR) environment.

In some implementations, the light is IR light. In some implementations, the light source is a LED. Alternatively, another type of light sources may be used that sufficiently provide a retinal-based image when the light from the light source is projected onto the eye.

The method 1600 may generate an image of a portion of the retina from an image sensor, the image corresponding to a plurality of reflections of the light reflected and/or scattered from the retina of the eye. For example, the sensor may be an IR image sensor/detector. The method 1600 may obtain a representation of the eye (e.g., an enrollment image/map). The representation may represent at least some of the portion of the retina. For example, the representation may be a map of the retina generated by having the user accommodate to a particular depth (e.g., infinity, 30 cm, 1 m, etc.), and scan through gaze angle space representative of the full desired field of view (e.g., a registration of an enrollment process). The captured images from such an enrollment phase may then be stitched together to form a map of the retina.

In some implementations, obtaining a representation of the eye is based on generating an enrollment image of the retina of the eye to be used with the eye tracking system (e.g., register a new user before using an eye tracking system). In an exemplary implementation, the representation of the eye includes a map of the at least some of the portion of the retina. In some implementations, generating the map of the at least some of the portion of the retina includes obtaining enrollment images of the eye of a user, and generating the map of the at least some of the portion of the retina based on combining (stitching) at least a portion of two or more of the enrollment images of the eye. In some implementations, obtaining enrollment images is performed while the user (i) accommodates the eye to a particular enrollment depth (e.g., infinity, 30 cm, 1 m, etc.), and (ii) scans through a gaze angle space representative of a defined field of view. For example, before the user can access/use a particular program on a device, the system performs a user registration process that includes capturing an enrollment image(s) of the retina that can be used during use of the program for eye tracking (e.g., a first time a new user uses an HMD). Some implementations do not require building a map of the retina. For example, such implementations may utilize enrollment images that are used as a database for a process (e.g., algorithm, machine learning model, etc.) that compares each new image to the database and determines the gaze angle accordingly.

The method 1600 may track an eye characteristic based on a comparison of the image of the portion of the retina with the representation of the eye. In some implementations, tracking the eye characteristic determines a position or orientation of the eye within a 3D coordinate system, e.g., relative to the device and/or the physical environment. In some implementations, tracking the eye characteristic is based on user accommodation distance determined via scaling and blurring. Several methods and/or combinations of methods may be utilized to track an eye characteristic based on a comparison of the image of the portion of the retina with the representation of the eye. In an exemplary implementation, tracking the eye characteristic based on the comparison of the image of the portion of the retina with the representation of the eye includes estimating a degree of defocus of a feature. In some implementations, estimating the degree of defocus of the feature is based on focus pixels (e.g., an imaging technique to determine focus/blur).

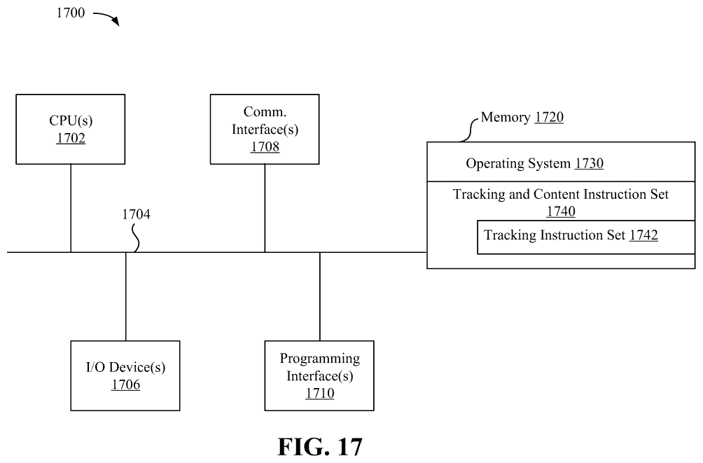

FIG. 17 is a block diagram of an example device 1700. Device 1700 illustrates an exemplary device configuration for device 120. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 10 includes one or more processing units 1702 (e.g., microprocessors, ASICs, FPGAs, GPUs, CPUs, processing cores, and/or the like), one or more input/output (I/O) devices and sensors 1706, one or more communication interfaces 1708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1710, one or more displays 1712, one or more interior and/or exterior facing image sensor systems 1714, a memory 1720, and one or more communication buses 1704 for interconnecting these and various other components.

In some implementations, the one or more communication buses 1704 include circuitry that interconnects and controls communications between system components. In some implementations, the one or more I/O devices and sensors 1706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 1712 are configured to present a view of a physical environment or a graphical environment to the user. In some implementations, the one or more displays 1712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 1712 correspond to diffractive, reflective, polarized, holographic, etc. waveguide displays. In one example, the device 10 includes a single display. In another example, the device 1700 includes a display for each eye of the user.

In some implementations, the one or more image sensor systems 1714 are configured to obtain image data that corresponds to at least a portion of the physical environment. For example, the one or more image sensor systems 1714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1714 further include illumination sources that emit light. In various implementations, the one or more image sensor systems 1714 further include an on-camera image signal processor (ISP) configured to execute a plurality of processing operations on the image data.

The memory 1720 includes high-speed random-access memory, such as DRAM, SRAM, DDR RAM, or other random-access solid-state memory devices. In some implementations, the memory 1720 includes non-volatile memory, such as one or more magnetic disk storage devices, optical disk storage devices, flash memory devices, or other non-volatile solid-state storage devices. The memory 1720 optionally includes one or more storage devices remotely located from the one or more processing units 1702. The memory 1720 includes a non-transitory computer readable storage medium.

In some implementations, the memory 1720 or the non-transitory computer readable storage medium of the memory 1720 stores an optional operating system 1730 and one or more instruction set(s) 1740. The operating system 1730 includes procedures for handling various basic system services and for performing hardware dependent tasks. In some implementations, the instruction set(s) 1740 include executable software defined by binary information stored in the form of electrical charge. In some implementations, the instruction set(s) 1740 are software that is executable by the one or more processing units 1702 to carry out one or more of the techniques described herein.

The instruction set(s) 1740 include tracking instruction set 1742, which may be embodied a single software executable or multiple software executables. In some implementations, the tracking instruction set 1742 is executable by the processing unit(s) 702 track an eye characteristic as described herein. It may determine eye position, orientation, accommodation, etc. based on a comparison of one or more captured images of a retina with a representation of the eye using one or more of the techniques discussed herein or as otherwise may be appropriate. To these ends, in various implementations, the instruction includes instructions and/or logic therefor, and heuristics and metadata therefor.

Although the instruction set(s) 1740 are shown as residing on a single device, it should be understood that in other implementations, any combination of the elements may be located in separate computing devices. Moreover, FIG. 17 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A device comprising:
a camera comprising a chamber with an aperture fitted with a lens through which captured light is received to form images that are projected onto a surface for recording or translation into electrical impulses, the camera lens having a lens optical axis and a lens aperture radius distance;
a light source configured to produce light that is directed towards a scattering optic;
the scattering optic positioned to produce diffuse light by scattering the light produced by the light source, wherein at least some of the diffuse light is directed from a position that is less than the lens aperture radius distance from the lens optical axis and directed towards a retina of an eye, and wherein the captured light comprises reflections of the diffuse light off of the retina; and
one or more processors configured to track the eye based on the images.

2. The device of claim 1, wherein an entirety of the scattering optic is within the lens aperture radius distance from the lens optical axis.

3. The device of claim 1, wherein:
the camera has an angle of view; and
the scattering optic scatters light across the entire angle of view of the camera.

4. The device of claim 1, wherein the scattering optic is configured to direct the diffuse light towards a retina of the eye from a fixed position relative to the eye, wherein the scattering optic is configured to illuminate at least a portion of the retina regardless of a rotational orientation of the eye.

5. The device of claim 1 further comprising a waveguide, wherein the light source directs the light source into the waveguide.

6. The device of claim 5, wherein the waveguide comprises the scattering optic and the scattering optic comprises a diffusion plate comprising a plurality of scattering elements.

7. The device of claim 6, wherein the plurality of scattering elements are etched into a surface of the waveguide.

8. The device of claim 6, wherein the plurality of scattering elements are particles injected into the waveguide.

9. The device of claim 5, wherein the waveguide comprises the scattering optic and the scattering optic comprises an embedded diffuser and partial back coating.

10. The device of claim 5, wherein the waveguide comprises the scattering optic and the scattering optic comprises a multi-directional output coupler.

11. The device of claim 10, wherein the multi-directional output coupler is positioned over an entirety of the aperture.

12. The device of claim 10, wherein the multi-directional output coupler is positioned over less than an entirety of the aperture.

13. The device of claim 1, wherein the light source comprises a collimated light emitting diode (LED).

14. The device of claim 13, wherein the scattering optic comprises a reflective diffuser.

15. The device of claim 13, wherein the scattering optic comprises a mirror coating on the lens.

16. The device of claim 1, wherein the light source and the scattering optic are within the chamber of the camera, wherein:
the light source comprises a light emitting diode (LED);
the scattering optic comprises a diffuser and a polarized beam splitter,
wherein the LED directs the directed light through the diffuser, the diffuser scatters the directed light, and the polarized beam splitter reflects the scattered light in the diffuse directions.

17. The device of claim 1, wherein the scattered light has a first polarization that is perpendicular to a second polarization of the captured light.

18. The device of claim 1, wherein the camera, light source, and scattering optic are housed within a housing that is affixed to a frame portion of a head-mounted device (HMD).

19. A device comprising:
a camera comprising a chamber with an aperture fitted with a lens through which captured light is received to form images that are projected onto a surface for recording or translation into electrical impulses, the camera lens having a lens optical axis and a lens aperture radius distance;
a light source configured to produce diffuse light, wherein at least some of the diffuse light is produced from a position that is less than the lens aperture radius distance from the lens optical axis and directed towards a retina of an eye, and wherein the captured light comprises reflections of the diffuse light off of the retina; and
one or more processors configured to track the eye based on the images.

20. The device of claim 19, wherein the light source is fastened at a position on a center of the lens.

21. The device of claim 19, wherein the light source comprises transparent wiring.

22. The device of claim 19, wherein the light source blocks less than 30% of the aperture.

23. The device of claim 19, wherein the light source comprises a light emitting diode [LED] or a light emitting diode VCSEL array.

24. The device of claim 21, wherein the light source is polarized.

25. A method comprising:
at an electronic device having a processor:
generating diffuse light directed towards a retina of an eye;
generating an image of the retina using a camera comprising a lens having a lens optical axis and a lens aperture radius distance, the image generated by capturing reflections of the diffuse light off of a retina of an eye, wherein at least some of the diffuse light is directed from a position that is less than the lens aperture radius distance from the lens optical axis; and
tracking the eye based on the image.
